(19) United States
(12) Patent Application Publication
(10) Pub. No.: US 2015/0175058 A1
(43) Pub. Date: Jun. 25, 2015

(54) LAMP FOR VEHICLE

(71) Applicant: SL Corporation, Daegu (KR)

(72) Inventors: Youngho Son, Gyungsan (KR); Hyo Jin Han, Gyungsan (KR)

(21) Appl. No.: 14/577,065

(22) Filed: Dec. 19, 2014

(30) Foreign Application Priority Data
Dec. 20, 2013 (KR) 10-2013-0159868

(51) Int. Cl. B60Q 1/28

(52) U.S. Cl. CPC B60Q 1/28

(57) ABSTRACT

A lamp for a vehicle has a lamp module including a light source and a light amount controller which controls the lamp module so that an amount of light in a central area in the width direction of the vehicle becomes greater than an amount of light in an edge area in the width direction of the vehicle.

### CROSS-REFERENCE TO RELATED APPLICATION

This application claims priority to Korean Patent Application No. 10-2013-0159868 filed on Dec. 20, 2013, which is herein incorporated by reference.

### BACKGROUND

1. Field of the Invention

The present invention relates to a lamp for a vehicle including a plurality of lamp modules which may secure a more natural view by adjusting the amount of light of each of a plurality of lamp modules.

2. Description of the Related Art

Lamps for a vehicle performs a lighting function (e.g., a head lamp, a fog lamp, and the like) for easily identifying an object around the vehicle and a signaling function (e,g, a direction indication lamp, a tail lamp, a brake lamp, a side marker, and the like) for informing drivers of vehicles and/or pedestrians around of the driving state of the vehicle.

A headlamp for a vehicle has an essential function of securing the driver's view at night by irradiating light in the vehicle's driving direction. It is difficult to make the optimal driving environment according to the vehicle's driving state such as the driving speed, driving direction, road condition, and surrounding brightness by using the headlamp.

Recently, an adaptive front lighting system, which adjusts the light distribution pattern according to the vehicle's driving state, was proposed. The adaptive front lighting system adaptively adjusts/converts the light distribution pattern by changing the cutoff pattern of the light which is generated from the light source. The driver of a vehicle may turn on the down light or up light for the night driving. In the case of the down light, the light distribution pattern may be converted through the adaptive front lighting system, and in the case of the up light, the light distribution pattern may be converted according to the vehicles in the front. Further, the adaptive front lighting system forms various light distribution patterns by blocking part of the light emitted from the light source by using a shield, and the light distribution pattern is inevitably limitative. That is, the adaptive front lighting system forms the light distribution pattern by adjusting the shielded direction of light of the light source and the blocked level of the light, but only the limited distribution patterns are formed due to the structural limit For example, according to the adaptive front lighting system, the light cannot be set to be irradiated or not to be irradiated at a certain point in the front.

Hence, there is a need of a lamp for a vehicle which forms various light distribution patterns.

### SUMMARY

The present invention provides a lamp for a vehicle including a plurality of lamp modules which may adjust the amount of light of each of the plurality of lamp modules which are arranged in a line.

In accordance with an aspect of the present invention, a lamp for a vehicle comprises a lamp module including a light source and a light amount controller which controls the lamp module so that an amount of light in a central area in the width direction of the vehicle becomes greater than an amount of light in an edge area in the width direction of the vehicle.

### BRIEF DESCRIPTION OF THE DRAWINGS

The above and other features and advantages of the present invention will become more apparent by describing in detail preferred embodiments thereof with reference to the attached drawings in which:

FIG. 1 illustrates a lamp module of a lamp for a vehicle according to an embodiment of the present invention;

FIG. 2 illustrates a side surface of the lamp module of FIG. 1;

FIG. 3 illustrates light irradiated from the lamp module of FIG. 1;

FIG. 4 illustrates lamp modules arranged in a line according to an embodiment of the present invention;

FIG. 5 illustrates a vehicle installed with the lamp modules of FIG. 4;

FIGS. 6-10 illustrate light distribution patterns of lamp modules according to an embodiment of the present invention; and

FIG. 11 illustrates a lamp module according to another embodiment of the present invention.

### DETAILED DESCRIPTION OF THE EMBODIMENTS

Reference will now be made in detail to exemplary embodiments, examples of which are illustrated in the accompanying drawings, wherein like reference numerals refer to like elements throughout. In this regard, the present exemplary embodiments may have different forms and should not be construed as being limited to the descriptions set forth herein.

Accordingly, the exemplary embodiments are merely described below, by referring to the figures, to explain aspects of the present description.

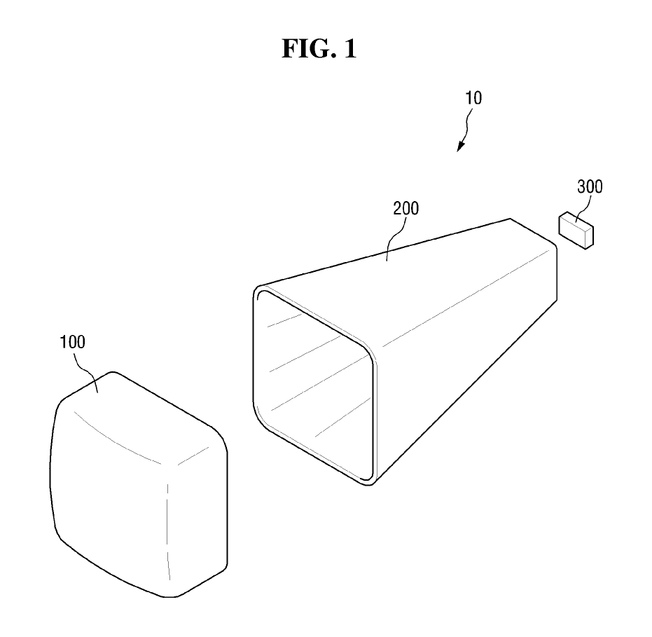

FIG. 1 illustrates a lamp module of a lamp for a vehicle according to an embodiment of the present invention. A lamp module 10 includes a lens 100, a tunnel 200, and a light source 300. As a non-limiting example, the light source 300 may be a projection-type light source as a light-emitting module which generates light. The projection-type head lamp has a characteristic of concentrating light into one point, and thus the projection-type head lamp is advantageous in terms of the light distribution effects compared to a general clear type and may give a sporty feeling to the front shape of a vehicle. As another non-limiting example, the light source 300 may be composed of a discharge bulb and a light-emitting unit which is emitted due to the discharge bulb, and the discharge bulb may be a metal halide bulb.

The lens 100 is provided at an end (“light emitting end”) of the tunnel 200 and the light source 300 is provide at the other end (“light incident end”) of the tunnel 200. The tunnel 200 guides light generated by the light source 300 toward the lens. At this time, at least some of the light of the light source 300 may be directly transmitted to the lens 100 without being reflected by the tunnel 200. The light source 300 may be provided inside or outside the tunnel 200. Likewise, the lens 100 may be provided inside or outside the tunnel 200. The light incident end and/or the light emitting end may be formed to have an opening (i.e., reflector type) and/or at least a part of the light incident end and/or at least a part of the light emitting end may be enclosed by or formed with an appropriate light-transmitting material. Hereinafter, the description will center on the case where the light source 300 is provided inside the tunnel 200.

A scattered layer or a spread layer may be formed on the surface of the inside of the tunnel 200. That is, when light is emitted from the light source 300, the light may be scattered by the tunnel 200 and may then be emitted in an evenly distributed state through the lens 100 in the front. In this case, the light emitted through the lens 100 may show a distribution in which the overall luminance is uniform as in the type in which the light is emitted from the surface light source.

The scattered layer, which is formed on the inner surface of the tunnel 200, may include minute irregularities of a repeated form, and the overall luminance may become uniform as the light is irregularly reflected by the minute irregularities.

The lens 100 projects light generated from the light source 300. Further, the lens 100 refracts light generated from the light source 300 to be directed toward the front. To this end, the lens 100 may have a focal point as a convex lens or a concave lens.

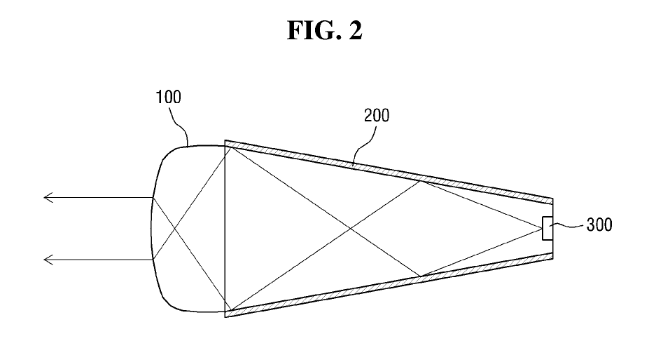

FIG. 2 illustrates a side surface of the lamp module of FIG. 1. The light, which is generated from the light source 300, is reflected in the inner surface of the tunnel 200 so as to be emitted through the lens 100. Further, though not illustrated in FIG. 2, the light generated from the light source 300, without being reflected on the inner surface of the tunnel, may be emitted directly through the lens 100.

The cross-section of the light emitting end may be formed to be greater than the cross-section of the light incident end so that the light generated from the light source 300 may be better transmitted to the light emitting end. In this case, the light generated from the light source 300 may be transmitted to the light emitting end with a less number of times of reflection, and thus the light loss due to the reflection may be reduced.

Further, FIG. 2 illustrates that the inner surface of the tunnel 200 is a straight line type, but the invention is not limited thereto. For example, it may have a predetermined regular or irregular curvature (e.g., concave, convex, or a combination thereof).

Likewise, the distribution pattern of light emitted from the light emitting end may be changed according to the curvature of the inner surface of the tunnel 200, and various beam patterns may be formed. Hence, the description below focuses on the case when the inner surface is a straight line type, but it should be noted that the embodiment is not limited thereto.

FIGS. 1 and 2 illustrate that the cross-sections of the light emitting and incident ends are a rectangle or a square. However, the invention is not limited thereto. For example, the cross sections of the tunnel 200, the lens, and/or the light source 300 may be other types of polygons, or a circle, or an eclipse.

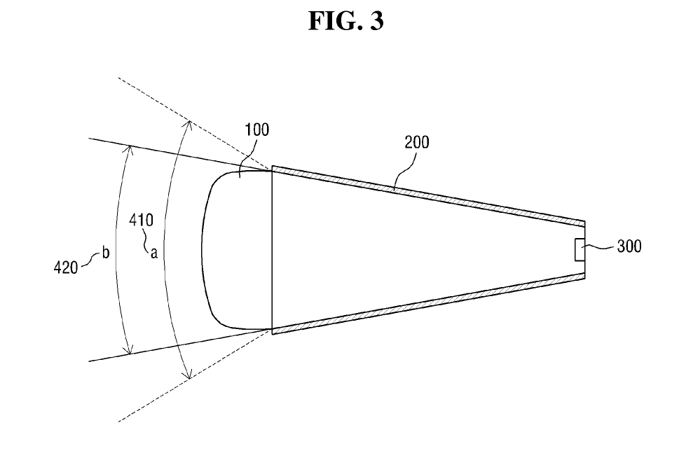

FIG. 3 illustrates light irradiated from the lamp module of FIG. 2. Light generated from the light source 300 is reflected on the inner surface of the tunnel 200 and is then emitted to the light emitting end. Here, the diffusion range of the emitted light is determined according to the lastly reflected angle. The diffusion range may be changed according to the distance between the light incident end and the light emitting end, the difference of the sizes of the cross-sections between the light incident end and the light emitting end, and the curvature of the inner surface of the tunnel. The reference number 410 of FIG. 3 refers to a wide diffusion range.

One of the purposes of the lamp module 10 of the present invention is to secure the view on a specific point in the front. To this end, it is preferred to have a narrow diffusion range rather than a wide diffusion range. That is, it is desirable to concentrate light on a specific point rather than irradiating light throughout a wide range. The lens 100 may refract transmitted light to be directed to a front side of the lens 100 so as to reduce the diffusion range. As a result, the light emitted from the lens 100 may be irradiated with a narrow diffusion range as shown in reference numeral 420 of FIG. 3, and the light may be irradiated toward a front side of the lens as shown in FIG. 2.

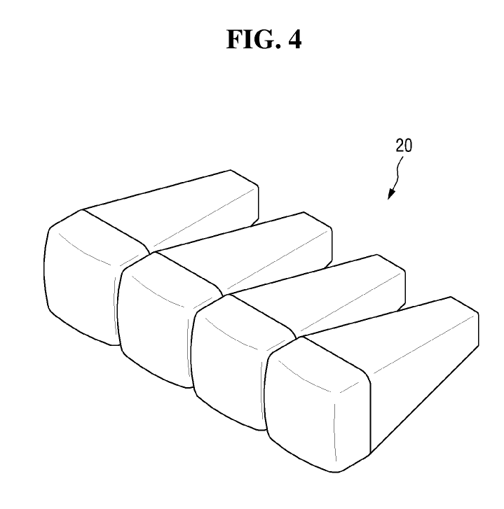

FIG. 4 illustrates lamp modules arranged in a line according to an embodiment of the present invention. A lamp for a vehicle of the present invention may include at least one lamp module, and as shown in FIG. 4, a plurality of lamp modules 20 may be horizontally arranged in a line. Each of a plurality of lamp modules included in a lamp for a vehicle may be controlled, and as such, light may be set to be irradiated on a specific point or not be irradiated on a specific point. Irradiation of light on a specific point may be determined according to the result of sensing the front side of the lens, and to this end, a sensing device (not shown) such as a camera and an ultrasonic transceiver may be provided.

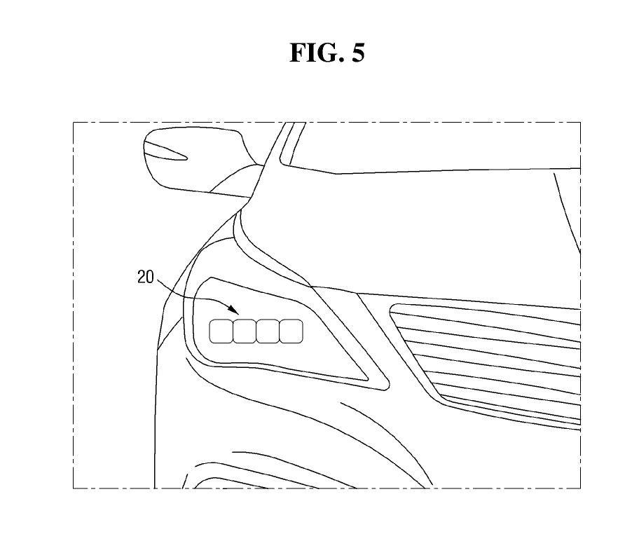

FIG. 5 illustrates a vehicle installed with the lamp modules of FIG. 4. A lamp for a vehicle including a plurality of lamp modules 20 may be arranged in front right and left sides of the vehicle. Here, various beam patterns may be formed by controlling distinctively controlling lamps at both sides or controlling a lamp module included in a specific lamp.

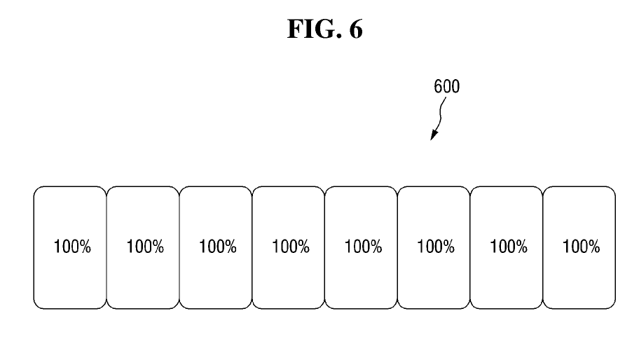

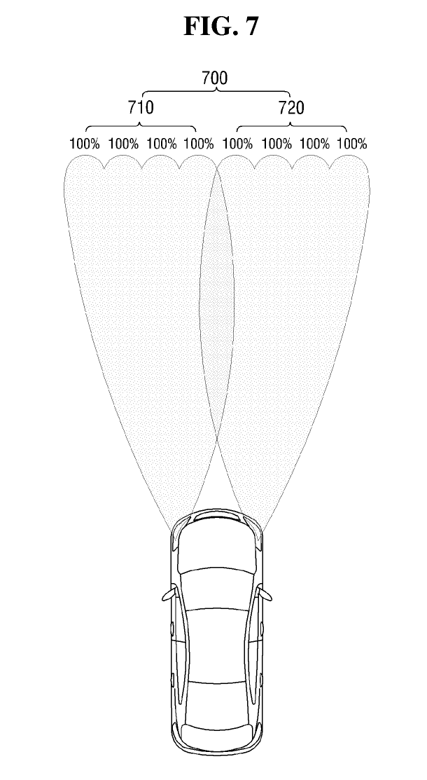

FIGS. 6-7 illustrate light distribution patterns of lamp modules according to an embodiment of the present invention. As described above, the light irradiated from a lamp module has a narrow diffusion range, and thus if the irradiated light is irradiated on a short distance screen, a light distribution pattern having a certain area is formed. Further, one lamp module may include a plurality light sources so that a plurality of beams may be irradiated. Here, a plurality of light distribution pattern areas 600 may be formed by each beam as in FIG. 6. Hence, the description below will focus on the case where the number of the light distribution pattern areas and the number of the lamp modules are the same, but it should be noted that the invention is not limited thereto. For example, 4 light distribution pattern areas may be formed by one lamp module, and 8 light distribution pattern areas may be formed by 4 lamp modules. Further, when there are a plurality of lamp modules, the numbers of light distribution pattern areas formed by respective lamp module may be the same or different. Further, one lamp module may include a light source module including one or more light emitting diodes, and the tunnel may guide light of each light emitting diode so as to be irradiated to the front. To this end, the tunnel may include a plurality of light guide units corresponding to respective light emitting diodes.

According to another embodiment of the present invention, the lamp module may include a reflector that can guide the light emitted from the lamp modules to the front of the module. The reflector may include at least one light reflecting unit which reflects light so as to be irradiated to a specific point. Here, one or more light emitting diodes may respectively correspond to one or more light reflecting units. That is, the light by one light emitting diode is reflected by the corresponding light reflecting unit so that the light is irradiated to a specific point in the front.

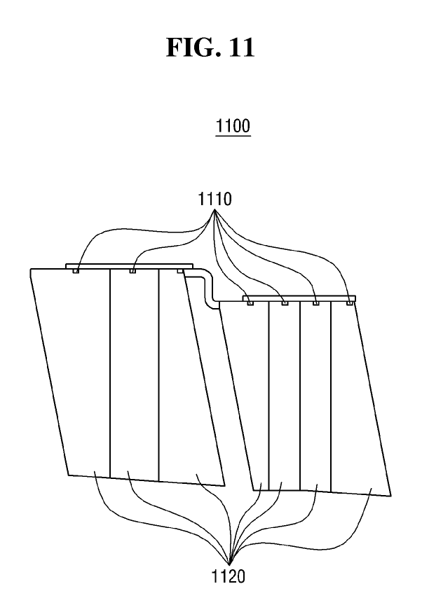

FIG. 11 illustrates a reflector including a plurality of light reflecting units 1120. That is, a lamp module 1100 which reflects light of a light source module by a multi focus reflector (MFR) so as to irradiate the light to the front. Here, the lamp module 1100 includes a light reflecting unit 1120 for each light emitting diode 1110. However, the lamp for the vehicle of the present invention may also be composed of a lamp module including one light reflecting unit for a plurality of light emitting diodes. Although the description below will focus on the case where the light distribution pattern is formed by a plurality of lamp modules, the invention is not limited thereto. In some embodiments, the light distribution pattern may be formed by one lamp module. In this case, the lamp module may include a tunnel and a light source module including a plurality of light emitting diodes. Alternatively, it may include a reflector and a light source module including a plurality of light emitting diodes.

Further, the lamp module of the present invention may be implemented as a projection type, a direct ray type, or a reflector type as well as a tunnel type and an MFR type.

FIG. 6 illustrates the formation of a plurality of light distribution pattern areas 600. 4 areas in the left side show the light distribution pattern areas by the left lamp and 4 areas in the right side show the light distribution pattern areas by the right lamp. Further, in FIG. 6, the value displayed at the inside of each area shows the amount of light corresponding to each area. Likewise, when all light distribution areas have the same amount of light, the light distribution pattern 700 illustrated in FIG. 7 is formed, which may provide an unnatural view to the driver. That is, the most important part to the driver is the front of the vehicle, but because the same amount of light is irradiated even to the side, the driver's eyes may be distracted. For example, when a driver is driving on a road where there are roadside trees, if the light distribution pattern 700 as in FIG. 7 is formed, the light is concentrated not only on the front, but also on the roadside tress, and thus the driver's eyes may be directed to both the front of the vehicle and the roadside trees. Further, the light distribution pattern 710 by the left side headlamp and the light distribution pattern 720 by the right side headlamp are the same, which may make the driver driving in the front or from the opposite direction uncomfortable. Further, the roadside trees may be closer than the front side, which is the point of interest to the driver, from the driver's vehicle. In this case, more light is irradiated on the roadside trees, and thus the roadside trees may be brighter than the front of the vehicle. Likewise, in a lamp for a vehicle including one or more lamp modules 20 which form a plurality of light distribution pattern areas, it may not be desirable to irradiate light so that the amounts of lights of all light distribution pattern areas become the same.

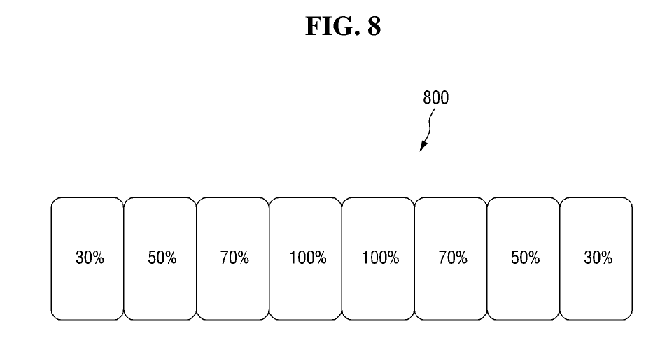

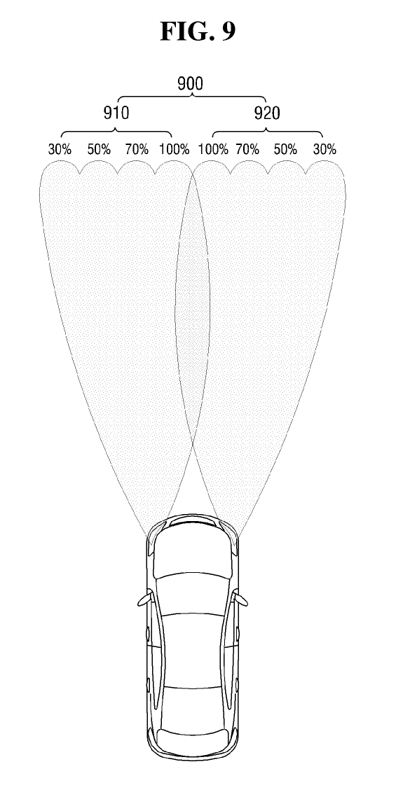

FIGS. 8 and 9 illustrate a light distribution pattern when the amount of light irradiated from the lamp module 20 is adjusted according to an embodiment of the present invention. FIG. 8 illustrates a light distribution pattern area 800 when light by the lamp module 20 is irradiated on a short distance screen. FIG. 9 illustrates a light distribution pattern 900 which is observed from the upper part of a vehicle.

As illustrated in FIG. 8, the amount of light of a plurality of light distribution pattern areas 800 according to an embodiment of the present invention may not be the same and may have a certain pattern. That is, the amount of light may decrease in the direction from the center to the edge. In FIG. 8, 4 left areas show the light distribution area by the left lamp and 4 right areas show the light distribution pattern area by the right lamp, and a greater amount of light may be concentrated on the front compared to the sides of the vehicle.

As such, light reaches farther to the front and the transmission of light is limited to the side of the vehicle, and thus the formation of the light distribution pattern 900 by different amounts of light is implemented as in FIG. 9.

The formation of such a light distribution pattern may be performed by a light amount controller (not shown). The light amount controller controls at least one lamp module 20 so that the amount of light in the central area of the width of a vehicle to become greater than the amount of the edge area of the width of the vehicle. For example, one or more lamp modules 20 may be controlled so that the amount of irradiated light may be reduced toward the edge area.

FIG. 9 illustrates light distribution patterns 910 and 920 by the left headlamp and the right headlamp. Here, the light amount controller separately controls the lamp module 20 in the left headlamp and the lamp module 20 in the right headlamp so that the amount of irradiated light may gradually decrease in the direction from one side of each lamp module 20 to the other side. The light amount controller in the present invention may control a lamp module according to a preset program or a user's command. As the light distribution pattern 900 as in FIG. 9 is formed, the front of a vehicle becomes brighter than the side area, and thus the driver's eyes are not distracted and the driver's eyes may be focused on the front of the vehicle.

As described above, the light amount controller may adjust the amount of light irradiated by headlamps at both sides by controlling the lamp module 20 which is provided at each of the headlamps at both sides of the vehicle. Here, the lamp module 20 may be controlled so that the amounts of light irradiated from the headlamps at both sides may become the same. For example, as illustrated in FIGS. 8 and 9, each lamp module may be controlled so that the light distribution patterns of the left headlamp and the right headlamp may become the same.

Further, as the light distribution pattern 900 as in FIG. 9 is formed, the inconvenience to the driver driving in the front or driving from the opposite direction may be reduced, but a light distribution pattern, which more significantly reduces inconvenience, may be formed.

That is, the light amount controller according to the present invention may control a plurality of lamp modules 20 so that the amounts of light irradiated from headlamps at both sides become different, thereby allowing formation of a light distribution pattern which reduces light which is irradiated on the vehicles on the front and the vehicles from the opposite direction.

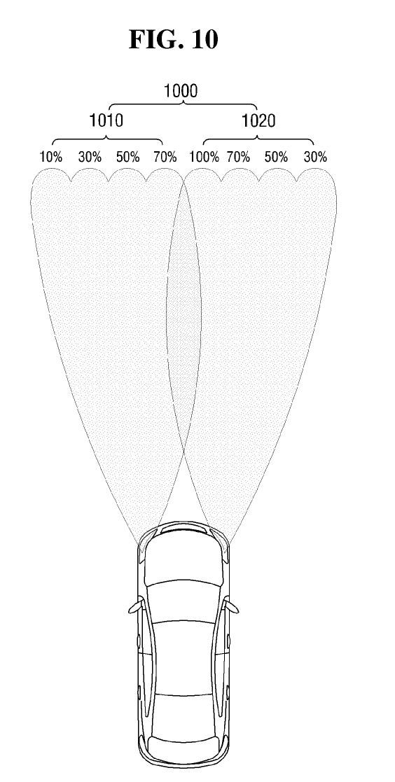

FIG. 10 illustrates a light distribution pattern 1000 when the amounts of light irradiated from a plurality of lamp modules are adjusted according to another embodiment of the present invention and illustrates light distribution patterns 1010 and 1020 when the amount of light at the left headlamp is adjusted to be smaller than the amount of light of the right headlamp. Such a light distribution pattern may be implemented to adjust only the average amount of light while applying the reduction ratio of the amount of light in the same manner. For example, as illustrated in FIG. 10, the amounts of light of the light distribution pattern area by the lamp module of the left headlamp may be adjusted to 10%, 30%, 50%, and 70%, and the amounts of light of the light distribution pattern area by the lamp module of the right headlamp may be maintained at 100%, 70%, 50%, and 30%. In such a case, the overall average amounts become different while the reduction ratio of the amount of light in the left headlamp and the right headlamp is kept same, and thus only the amounts of light become different while the light distribution pattern by the left headlamp and the light distribution pattern by the right headlamp have a similar form.

Alternatively, the light amount controller may control the lamp module so that various light distribution patterns may be formed. For example, the amounts of the light distribution pattern area by the lamp module of the left headlamp may be uniformly adjusted to 50% while the amount of the light distribution pattern area by the lamp module of the right headlamp is maintained same, and the adjustment of the amount of light of the right headlamp may be performed along with the adjustment of the amount of light of the left headlamp.

Further, only specific light distribution pattern areas may be turned on and the others may be turned off so that light may be irradiated only on a specific object in the front, and only specific light distribution pattern areas may be turned off and the others may be turned on so that light may not be irradiated only a specific point.

According to a lamp for a vehicle according to embodiments of the present invention, a more natural view may be secured by adjusting the amount of light of each of a plurality of lamp modules which are arranged in a line in a lamp for a vehicle including the plurality of lamp modules.

It should be understood that the exemplary embodiments described therein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. A lamp for a vehicle comprising:
a lamp module including a light source; and
a light amount controller which controls the lamp module so that an amount of light in a central area in the width direction of the vehicle becomes greater than an amount of light in an edge area in the width direction of the vehicle.

2. The lamp of claim 1, wherein the light amount controller controls the lamp module so that the amount of the irradiated light may decrease going from the central area toward the edge area.

3. The lamp of claim 2, wherein the lamp module is provided in a head lamp or head lamp module of the vehicle.

4. The lamp of claim 3, wherein the lamp module is provided in head lamps or head lamp modules at left and right sides of the vehicle and the light amount controller controls the lamp modules so that the amounts of light irradiated from the headlamps become the same or different.

5. The lamp of claim 1, wherein the lamp module has a light emitting diode or diodes as the light source.

6. The lamp of claim 1, wherein the lamp module further includes a lens and a tunnel, such that the light source is provided at one end of the tunnel and the lens is provided at the other end of the tunnel, thereby allowing the tunnel to guide light from the light source to the lens.

7. The lamp of claim 1, wherein the lamp module further includes a reflector which reflects light from the light source or sources.

8. The lamp of claim 7, wherein reflector includes multiple reflecting units.

9. The lamp of claim 8, wherein the light source is light emitting diodes and the respective reflecting units correspond to respective light emitting diodes.
